(19) United States
(12) Patent Application Publication
(10) Pub. No.: US 2008/0034420 A1
(43) Pub. Date: Feb. 7, 2008

(54) System and method of portal customization for a virtual private network device

(75) Inventor: Arthur Chang, Fremont, CA (US)

Correspondence Address: BUCHANAN, INGERSOLL & ROONEY PC, POST OFFICE BOX 1404, ALEXANDRIA, VA, 22313-1404, US

(73) Assignee: Array Networks, Inc., Milpitas, CA (US)

(21) Appl. No.: 11/498,330

(22) Filed: Aug. 1, 2006

(51) Int. Cl. G06F 15/16

(52) U.S. Cl. 726/15

(57) ABSTRACT

A method and system for generating a customized portal for a virtual private network (VPN) device, which includes hosting of at least one customized portal page on the VPN device. The method includes configuring at least one custom portal page for a virtual private network (VPN) device, the at least one custom portal page having content tags and portal customization tags adapted to produce a portal theme; importing the content tags and the portal customization tags into the VPN device for hosting; and replacing the content tags and the portal customization tags with content when served to a client, wherein the content tags and the portal customization tags generate a portal theme when served to the client.

### FIELD OF THE INVENTION

This invention generally relates to a system and method of portal customization, and more particularly to a system and method of portal customization for a virtual private network (VPN) device.

### BACKGROUND OF THE INVENTION

One of the most utilized networks for interconnecting distributed computer systems is the Internet. The Internet allows user of computer systems to exchange data throughout the world. In addition, many private networks in the form of corporate or commercial networks are connected to the Internet. These private networks are typically referred to as an “intranet.” To facilitate data exchange, the intranet generally uses the same communications protocols as the Internet. These Internet protocols (IP) dictate how data is formatted and communicated. In addition, access to corporate network or intranets are normally controlled by network gateways, which include a multi-layer SSL firewall system, which includes a networking architecture where the flow (associated streams of packets) is inspected both to and from the corporate network. The multi-layer SSL firewall systems are often referred to a virtual private network (VPN) device or gateway, such as those sold by Array Networks of Milpitas, Calif.

As the popularity of the Internet grew, businesses turned to it as a means of extending their own networks. First came intranets, which are password-protected sites designed for use only by company employees. Now, many companies are creating their own VPN (virtual private network) to accommodate the needs of remote employees and distant offices. A VPN is a private network that uses a public network (usually the Internet) to connect remote sites or users together. Instead of using a dedicated, real-world connection such as leased line, a VPN uses “virtual” connections routed through the Internet from the company's private network to the remote site or employee.

As such, the Virtual Private Network (VPN) is a network tunnel created for encrypted data transmission between two or more authenticated parties. This ensures data privacy, data integrity and data authenticity. Virtual private networks use a public shared network infrastructure such as the Internet as the means for transport. VPN data is encapsulated inside tunnels for travel through the public network.

From the technical standpoint, the traditional virtual private network (VPN) device or gateway provides wide area network (WAN) connectivity from a remote user to an office local area network (LAN). The VPN WAN connection implements a so-called OSI layer 2 extension or “conduit” of the office network itself between the LAN and the remote user. A remote client device, connected through a VPN device to an office LAN, locally appears on the LAN, as far as that user is concerned, as if that client device were directly connected to it. In essence, for packets destined from the client device to the LAN, a VPN connection there between involves, at a near end of the VPN connection, encapsulating outgoing OSI layer 3 packets at the client PC into layer 2 IP (Internet protocol) packets and transmitting those layer 2 packets over the VPN connection (in effect tunneling those layer 3 packets through the VPN connection), and subsequently, at a remote (LAN) end of the VPN connection, disassembling the layer 2 packets to yield the layer 3 packets and applying the resulting layer 3 packets onto the LAN for carriage to their ultimate destination, such as a network server. The opposite operation occurs in reverse for packets emanating from LAN, e.g., the server, and destined, over the VPN connection, to the remote client device. Since the layer 2 packet tunneling is totally transparent to both the LAN and the client device, advantageously the client device can provide the same level of functionality to its user as if that client device were directly connected to the LAN.

The VPN device prevents unauthorized users from accessing the system by using an authentication, authorization and accounting/auditing system known as AAA. The VPN device can also restrict and track the movement of data from inside the VPN device to systems outside the VPN device. The operation of the VPN device is determined by security policies, as contained within the authentication and authorization server or an AAA server. The authentication and authorization (or AAA) servers are used for more secure access in a remote-access VPN environment. When a request to establish a session comes in from a remote user or client, the request is proxied via an authentication and authorization module or service within the VPN device to the authentication and authorization or (AAA) server. The authentication and authorization (AAA) server will check: Who you are (authentication); What you are allowed to do (authorization); and What you are actually doing (accounting/auditing). Accounting information is typically used in tracking client use for security auditing, billing or reporting purposes.

Typically, current portal page do not provide any customization options aside from allowing a custom logo image and a welcome message to be specified. If a customer requires a more extensive customization, they must create their own portal page and host it on an external server. Unfortunately, if this is done, the customer or user will lose the ability to have web and fileshare links filtered by the ACL mechanism, and the customer or user will be unable to launch the Application Manager and the L3VPN Client from the portal page. In addition, the hosting of a customized portal page on an external server introduces a point of failure for the network. Accordingly, what is needed is a system and method of portal customization using a Virtual Private Network device or gateway.

### SUMMARY OF THE INVENTION

In accordance with one embodiment, a method of generating a customized portal page for a virtual private network (VPN) device comprises: configuring at least one custom portal page for a virtual private network (VPN) device, the at least one custom portal page having content tags and portal customization tags adapted to produce a portal theme; importing the content tags and the portal customization tags into the VPN device for hosting; and replacing the content tags and the portal customization tags with content when served to a client, wherein the content tags and the portal customization tags generate a portal theme when served to the client.

In accordance with another embodiment, a method of generating a customized portal page for a virtual private network (VPN) device comprises: configuring at least one custom portal page for a virtual private network (VPN) device having static content tags and dynamic content tags, wherein the static and dynamic tags describe how the text should be formatted when a browser displays the content tags; importing the static and dynamic content tags into the VPN device; hosting the static and dynamic content tags on the VPN device; and replacing the static and dynamic content tags with content when served to a client.

In accordance with a further embodiment, a system for customizing a portal page comprising: a virtual private network (VPN) device, the VPN device comprising: at least one server configured to host the customized portal page, the customized portal page having static content tags and customized portal tags; a web server for serving the portal page associated therewith; a network access server used by the Internet service provider (ISP) for the client to access the VPN device; and a VPN network and policy management device.

### BRIEF DESCRIPTION OF THE DRAWINGS

The invention will now be described in greater detail with reference to the preferred embodiments illustrated in the accompanying drawings, in which like elements bear like reference numbers, and wherein:

FIG. 1 shows a schematic diagram of a virtual private network (VPN) device in use according to one embodiment.

FIG. 2 shows a schematic diagram of a virtual private network (VPN) device in use with a LAN according to a further embodiment.

FIG. 3 shows a schematic diagram of a virtual private network (VPN) device in use with a WLAN according to another embodiment.

FIG. 4 shows a schematic diagram of a virtual private network (VPN) device in use with a LAN according to a further embodiment.

FIG. 5 shows a schematic diagram of a client device having a customized portal page.

FIG. 6 shows a flow chart of a method and system of providing a customer with the ability to customize a portal page of a VPN device without having to host the page on an external server.

FIG. 7 shows a flow chart for the importation of the portal page content on a local host of a VPN device.

FIG. 8 shows a flow chart for retrieval and delivery of the customized portal page to the client.

### DETAILED DESCRIPTION

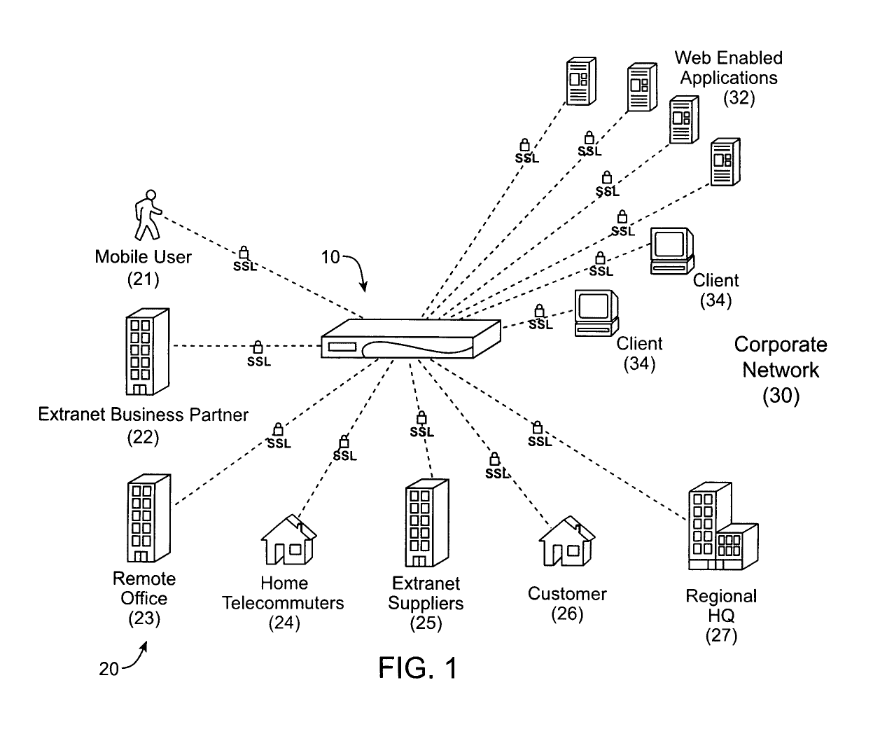

FIG. 1 shows a schematic diagram of a virtual private network (VPN) device 10, or VPN gateway, in accordance with one embodiment. As shown in FIG. 1, the VPN device 10 is configured to accommodate the needs of remote users 20 to access web enabled applications 32, within a corporate network 30. Typically, within the corporate network 30, remote users 20 via the VPN device 10 will have direct access to web enabled applications 32, which can include e-mail and other resources. In addition, these web-enabled applications 32 can be available to clients 34 within the network 30. As shown in FIG. 1, the remote users 20 can include mobile users 21, extranet business partners 22, remote offices 23, home telecommuters 24, extranet suppliers 25, customers 26, and regional headquarters 27, which are only some of the remote users 20 who may access the corporate network 30 via the VPN device 10.

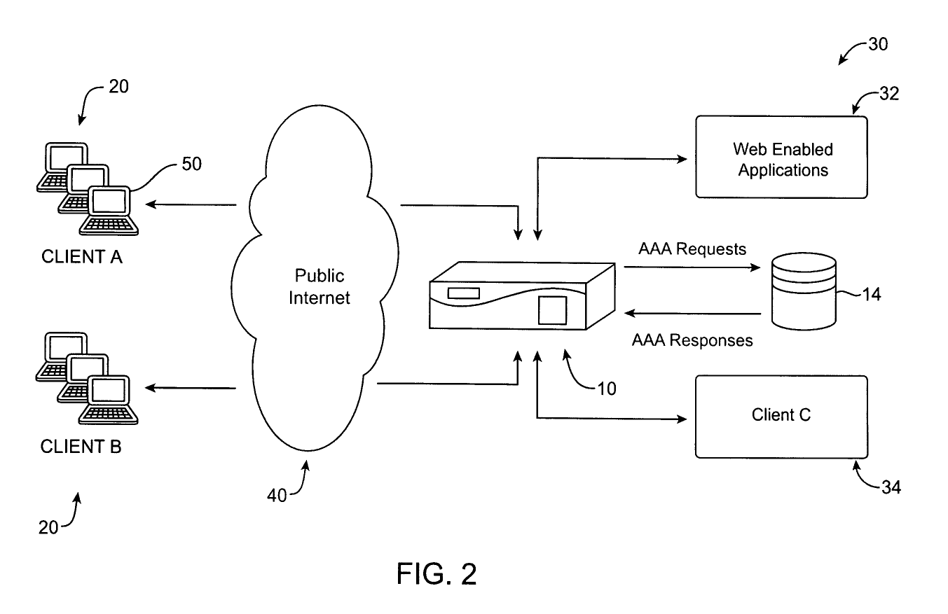

FIG. 2 shows a schematic diagram of a virtual private network device 10 in use with a LAN according to a further embodiment. As shown in FIG. 2, the VPN device or gateway 10 is configured to connect the remote user 20 to the corporate network or local area network (LAN) 30, which can include a plurality of web-enabled applications 32, such as managed e-mail services via a public network or communications link, such as the Internet 40. The remote users and/or clients (client A or client B) 20 access the web enabled applications 32 on the corporate network 30 via the ISP network 100. The remote user and/or client 20 preferably access the network 30 via a client device 50. It can be appreciated that the client device 50 can be a computer or other suitable device for accessing web enabled applications within a corporate intranet or network 30, including PDAs, cellular phones, Blackberry® type devices and other wireless devices.

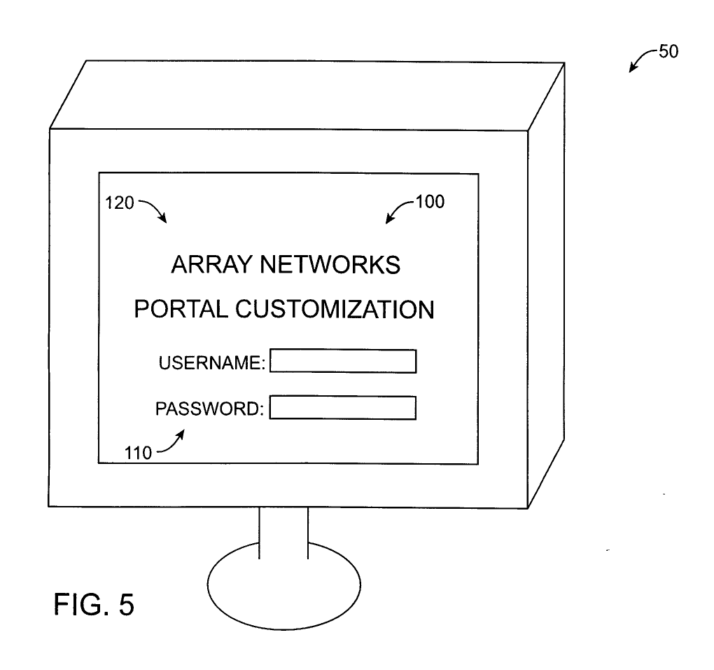

As shown in FIG. 2, the remote users 20 access the ISP network 100 and corporate network 30 via the VPN device 10. In use, the remote users 20 can access enabled applications including e-mail, from both local and remote locations through a client device 50 via a web portal or portal page 100 (FIG. 5), which is a site on the World Wide Web that typically provides personalized capabilities to their visitors. It can be appreciated that the portal page 100 can be designed to use distributed applications, different numbers and types of middleware and hardware to provide services from a number of different sources. In addition, business portals are designed to share collaboration in workplaces. When the remote users 20 establishes a session via the VPN device 10, the remote user or client 20 establishes a tunnel using the SSL protocol, which requires that the user authenticate via an authentication/authorization server 14 associated with the VPN device 10.

It can be appreciated that the authentication/authorization server 14 can be an authentication, authorization, and accounting (or auditing) server 14 (also known as an “AAA”), which typically includes a set of authentication interfaces, to which the VPN device 10 integrates easily. The AAA server 14 can be any suitable server or authentication or database, including but not limited to an external LDAP, Microsoft Active Directory, RADIUS, RSA SecurID server or a local authentication database.

For an additional level of protection, the VPN device 10 supports authentication that identifies clients 20 and associates them with user sessions based on unique certificates. The authorization role provides the VPN device 10 with a regulation for the security policy. Typically, the VPN device 10 allows administrators to limit access to information and applications based on a user's role within the organization. However, policies are typically flexible enough to meet the most complex requirements while allowing changes and updates to be applied quickly and easily. Accordingly, to minimize integration complexity, the VPN device 10 allows policies to be stored locally as well as on an external server (not shown). In addition, the authentication and authorization server (AAA) 14 can include an extensive audit trail, which can be a primary requirement for all security related regulations and policies. Typically, the VPN device 10 generates audit information in formats that allow easy analysis for both security and status monitoring purposes.

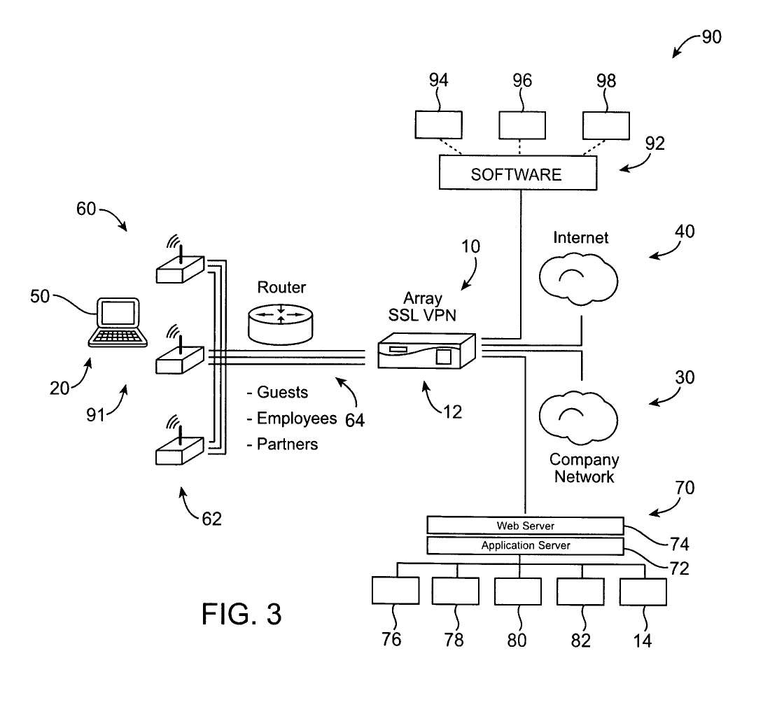

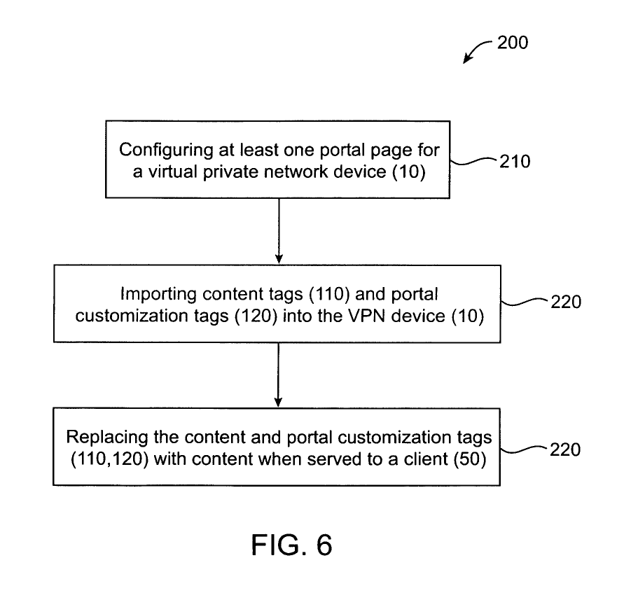

FIG. 3 shows a schematic diagram of a virtual private network (VPN) device 10 in use with a Wireless Local Area Network (WLAN) 60 according to another embodiment. As shown in FIG. 3, the VPN device or gateway 10 provides network access (to the corporate network) and Internet access using the same VPN device or gateway 10. The wireless LAN 60 uses one or more wireless access points 62, which connect the wireless or remote users 20 to a wired network 64. Thus, regular employee access usually requires access to the corporate or company network 30, and from there employees may access the Internet 40. On the other hand guest access should not be allowed under any circumstances for access to the corporate or company network 30, and should be only allowed to the Internet 40 directly. On the front-end different virtual portals or portal pages 100 can be configured for guest and employee access. Meanwhile, on the backend virtual routing is used to assure that guests access the Internet 40 directly without passing through the corporate network 30. In addition, it can be appreciated that since most remote users 20 do not require full network access, web-based applications 32 can be accessed through a web browser 52 (FIG. 6). However, since some users 20 require full layer-3 access (Layer3VPN), the VPN device 10 is preferably configured to provide full layer-3 access when needed.

As shown in FIG. 3, the VPN device 10 typically includes an outer casing 12, having enclosed therein hardware components (or hardware) 70 and software components (software) 90. The hardware components 70 or physical part of the VPN device 10, typically include the digital circuitry, as distinguished from the computer software or software components 90 that execute within the hardware 70. The hardware 70 preferably includes at least one application server 72 having the ability to host a customized portal page 100, a web server 74 for serving the portal page 100 associated, a network access server 76 (NAS) and/or card used by the Internet service provider (ISP) for the remote user and/or client 20 for VPN access, and a VPN network and policy management device 78. It can be appreciated that the VPN device 10 also preferably includes a web accelerator 80 that reduces web site access times, and at least one proxy server 82. The at least one proxy server 82 preferably includes a mail proxy configured to retrieve additional information from the authentication and authorization server or AAA server 14 (e.g. LAP, RADIUS etc.) regarding incoming and outgoing e-mail servers associated with the ISP. The VPN network and policy management center 78 is preferably in the form of an AAA server 14. However, other suitable VPN network and policy management devices 78 including firewalls, encryption, including symmetric-key encryption and/or public-key encryption, IPSec (IP security) and/or an AAA server 14 can be used.

The VPN device 10 also includes an operating system 92 (i.e., software component) having a kernel 94, which is responsible for the communication between hardware 70 and software components 90. The kernel 94 provides abstraction layers for the hardware components 70, especially for memory, processors and communication between hardware and software. In addition, the kernel 94 can also provide software facilities to userland applications such as process abstractions, interprocess communication and system calls. As shown in FIG. 3, the software components 90 can also include application software 96, including web-based applications, a file access module, a client/server application manager, a thin client support and a Layer 3 VPN, and an application acceleration module 98, including a hardware-based SSL accelerator and hardware compression module. In addition, each remote user or client 20 includes software 91 for connecting the client 20 to the VPN device 10.

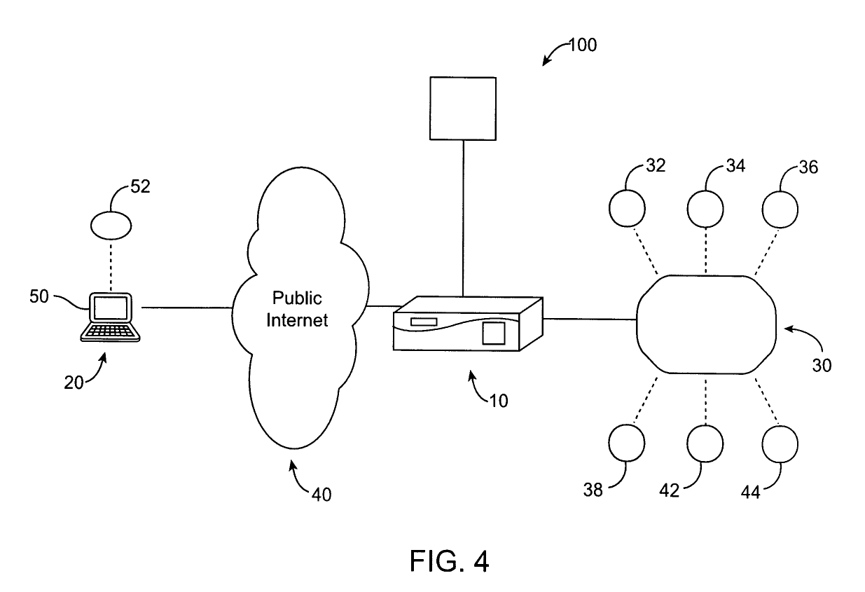

FIG. 4 shows a schematic diagram of a virtual private network (VPN) device 10 in use with a local area network (LAN) or corporate network 30 according to a further embodiment. The LAN or corporate network 30 can include web-enabled applications 32, internet access 34, user desktop 36, other desktops 38, other servers and appliances 42, active directory, RADIUS, LDAP or local user database servers 44. It can be appreciated that the VPN device or gateway 10 preferably is configured to provide support for the any of the web enabled application 32 natively through a Web browser 52, such as Internet Explorer®, Firefox®, Safari® or Netscape®, without the need for any client side component (ActiveX, Java Applets or any other components). In addition, the VPN device or gateway 10 typically provides for native access to both CIFS (Common Internet File System) and NFS (Network File System) shared directories without the need for any client side component (ActiveX, Java Applets or any other component) and provide a variety of network access solutions utilizing both Java and/or ActiveX based components.

FIG. 5 shows a perspective view of a client device 50 for remote access to a LAN or corporate network 30. The client device 50 includes a Web browser 52 or application (not shown), such as Microsoft® Internet Explorer®, Firefox®, Apple® Safari® or Netscape® Navigator®, which provides access to the VPN device 10, which hosts the portal page 100. The Web browser 52 connects to the VPN device 10 (or Web server on the Internet) and initiates a request for the portal page 100 of the corporate network 30 via the VPN device or gateway 10. The browser 52 retrieves the portal page 100 through the network connection 40 (i.e., internet) and delivers the portal page 100 to the client device 50 (or machine). Once the portal page 100 is retrieved, the Web browser 52 interprets a first set of static tags 110 (preferably with HTML commands) within the portal page 100 in order to display the page on the client's 50 screen (or user interface) as the page's creator intended it to be viewed. The portal page 100 for a VPN device 10 is typically comprised of a text file that contains not only text, but also a first set of static tags 110 that describe how the text should be formatted when the browser 52 displays it on the screen/user interface 54. The first set of static tags 110 provide instructions to the Web browser 52 on how the page 100 should look when it is displayed, including providing the web page or portal page 100 with different fonts, colors, headlines and embed graphics. The Web browser 52 also interprets these tags 110 to decide how to format the text onto the screen. Most web pages or portal pages 100 are formatted with tags 110 in the form of HTML (HyperText Markup Language); however, it can be appreciated that other language could be used. In addition, since a HTML web or portal page is typically static, if the portal page 100 includes dynamic features another or second set of (dynamic) content tags are needed.

Typically, while a portal page 100 having a set of HTML commands or (static) tags 110 is fine for static pages, a second set of (dynamic) content tags is needed for more dynamic content. For example, to add a footer or header to all files, or to insert document information automatically into the portal page 100. The dynamic content can be added to a web page or portal 100 via a Common Gateway Interface (CGI) protocol or any suitable standard protocol for interfacing external application software with an information server (not shown). However, VPN devices 10 typically provide for dynamic document or content delivery using an external server (not shown). The dynamic content is stored on the external server in a content format known as Server-Side-Includes or SSI. Server Side-Includes allows the programmer to embed a number of special “commands” or tags into the HTML commands. When the server reads an SSI document, it looks for the special commands or tags and performs the necessary action. Typically, since all SSI commands are stored within the HTML in HTML format, pages tagged with shtml reveal that “Server Side Includes” are being used on the server. Accordingly, while Htm and Html pages are static, the file is lifted off the server's disk and sent verbatim to the client. With SSI, a Web page or portal page 100 can contain a second set of (dynamic) tags indicating that another file should be inserted in place of the dynamic tag in the existing page. Thus, the web or portal page 100 is lifted off the server's disk and the server makes all the substitutions indicated. The server then sends the final page 100 to the client device 50. It can be appreciated, however, that if a VPN customer requires a more extensive customization, they typically must create their own portal page 100 and host it on the external server. Unfortunately, if this is done, the VPN customer or user will lose the ability to have web and fileshare links filtered by an access control list (ACL) mechanism within the VPN device 10.

In addition, some of the functionality of the VPN device 10 can be lost with an external server hosting the dynamic content. For example, if the external server hosting the dynamic content in a local area network (LAN) or corporate network 30 having one or more VPN devices 10 fails, or is temporarily offline or down, this can effect the VPN devices 10 performance and possible result in the VPN device 10 being offline or down temporarily. In addition, the external hosting of dynamic content requires a firewall or similar device between the VPN device 10 and the external server, which affects the security of the VPN device 10.

It can be also be appreciated that if the hosting of the customized portal page 100 is on an external server, the customer or remote user 20 will be unable to launch some web-enabled applications, such as an Application Manager and an L3VPN Client from the portal page 100. Alternatively, if the VPN device 10 includes a local host or host 150, which is configured to host the customized portal page 100 with the portal customization tags 120, which are added to provide dynamic content or documents 122, the security provided by the VPN device 10 can be maintained.

Accordingly, it would be desirable for a customized portal page to be hosted on the VPN device 10, in order for the VPN device 10 to maintain its ability to filter or prevent unauthorized use. It can be appreciated that the customized portal page 100 can be configured using portal customization tags 120, which are hosted by the VPN device 10. The portal customization tags 120 provide the VPN device 10 with the ability to filter the web and fileshare links via the ACL by determining the appropriate access rights to a given object depending on certain aspects of the process that is making the request, including the process's user identity. In addition, it can be appreciated that the access rights of each remote user 20 will be maintained within the AAA server 14, including the specific individual user or group rights to specific system objects, such as a program, a process, or a file.

FIG. 6 shows a flow chart of a method and system 200 of providing a customer with the ability to customize a portal page 100 of a VPN device 10 without having to host the page 100 on an external server. The method and system 200 includes the configuration 210 of at least one custom portal page 100 for a virtual private network (VPN) device 10, the at least one custom portal page having content tags 110 and portal customization tags 120 adapted to produce a portal theme. The content tags 110 and the portal customization tags 120 are imported 220 into the VPN device 10 for hosting. Upon request, the content tags 110 and the portal customization tags 120 are replaced 230 with content when served to a client, wherein the content tags 110 and the portal customization tags 120 generate a portal theme when served to the client 50.

As shown in FIG. 6, the system and method 200 includes a local host or host within the VPN device 10, which includes a set of portal customization tags 120, which provide dynamic content to the portal page 100. The portal customization tags 120 preferably provide functionality similar to Server Side Includes (SSI) type language, to include dynamic data in a static HTML portal page 100. In addition, by including special non-HTML tags or customized portal tags 120 in the portal page content, the developer is able to instruct the web sever 74 within the VPN device 10 to replace the customized portal tags 120 with various dynamic content. It can be appreciated that with the use of these portal customization tags 120, customers can design their own custom portal pages 100 while still taking advantage of the VPNs 10 capabilities. In use, the developer would insert portal customization tags 120, such as: “web links” or L3VPN Client” into the portal page 100, and when the VPN device or gateway 10 encounters these tags 120, the VPN device 10 will replace the portal customization tags 120 with the actual referenced content. This allows the customer the flexibility of completely customizing their portal pages 100, while still allowing the customer to have the same functionality as provided by the default portal pages of the VPN device 10.

Typically, with most VPN devices or gateways 10, administrators (or programmers) can configure the custom login, portal, logout, and error pages. However, in order to extend the functionality of the VPN device 10, with the ability of the VPN device 10 to provide for portal customization, including an ability to include a plurality of “portal themes,” it is necessary to confine the hosting of the customized portal page 100 to a local host 150 within the VPN device or gateway 10. It can be appreciated that by hosting the portal customization on the VPN device 10, the security and tunneling provided by a VPN device or gateway 10 is still maintained.

It can be appreciated that with the hosting of the portal customization tags 120 on the VPN device 10, the customer and/or end user or client 20 can incorporate different portal themes into the portal page 100. For example, for a large company with several different divisions or groups which access the corporate network 30 via a single VPN device 10, customized portal pages 100 having different themes can be designed for each company or group of users. In addition, it can be appreciated that individual users or clients could also select individual portal page themes from a plurality of portal themes. The portal themes can be based on various parameters, including the ability of the customer to provide different access to portions of the network and/or information to individual groups and/or remote users.

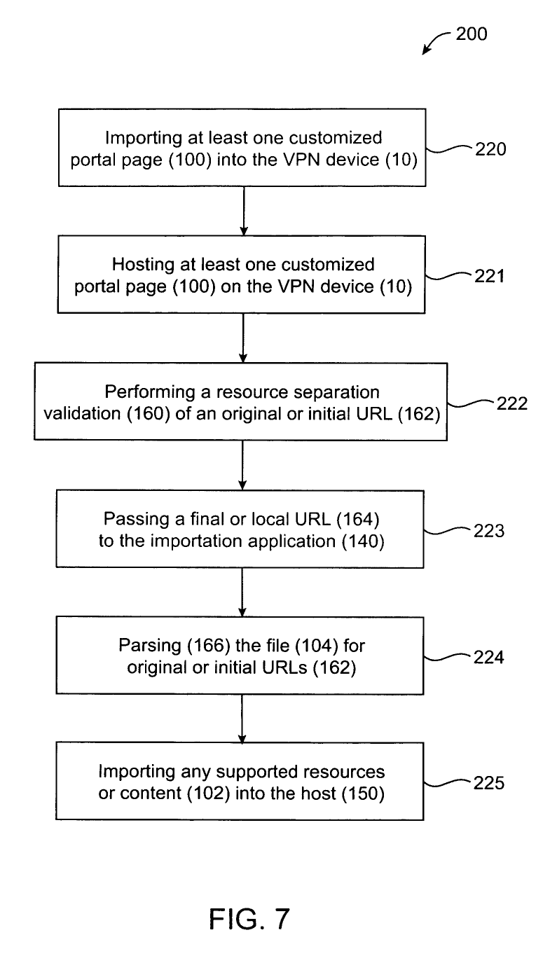

FIG. 7 shows a flow chart for the importation 220 of the portal page content 102 to a local host 150 of a VPN device 10. As shown in FIG. 7, for each of the configured portal pages 100, the page 100 can be imported into the VPN 10 using an importation application or agent 140 for hosting 221. It can be appreciated that the importation agent 140 can be any suitable application, which can import the portal customization tags 120 to the VPN device 10. In one embodiment, the VPN device 10 will preferably be used as the host 150 to store the content 102 of the portal pages 100. However, the host 150 can be any userland or application space, including Unix or Unix-like operating systems, which are external from the kernel, or the kernel. It can be appreciated, that the configured portal page content 102 are preferably preserved across reboots and system upgrades.

In addition, the VPN device 10 also preferably includes a resource separation module 160, which is used to perform resource separation validation 222 of an original or initial URL 162 for any content and the passing of a final or local URL 164 to the importation agent 140. It can be appreciated that any suitable module, which can perform resource separation validation and then pass 223 the final or local URL to the importation agent 140 can be used.

The importation agent 140 will then parse 224 the file 104 for original or initial URLs 162 and import 225 any supported resources that it finds into a directory 154 within the VPN device 10. The importation agent 140 will then rewrite the original or initial URLs 162 for these imported content 102 and resources to point to the local path (local URL 164). For example, modified or local URL 164 can read as follows:
/prx/000/http/localhost/<object_name>/<resource>

It can be appreciated that the parsing of the original or initial URL 162 can be performed with a HTML parser 166. For example, the HTML parser 166 can be modified copy of a WRM (Web Resource Mapping) HTML parser or any other suitable HTML parser. Accordingly, for each of the documents or content, which is imported into the host 150, the documents or content 102 is preferably converted from its original Uniform Resource Locator (URL) 162 to a local URL 164. The pages will then be parsed for embedded content links, and any content found (style sheet, images, JavaScript, etc.) can be automatically imported into the rewritten or modified local URL 164.

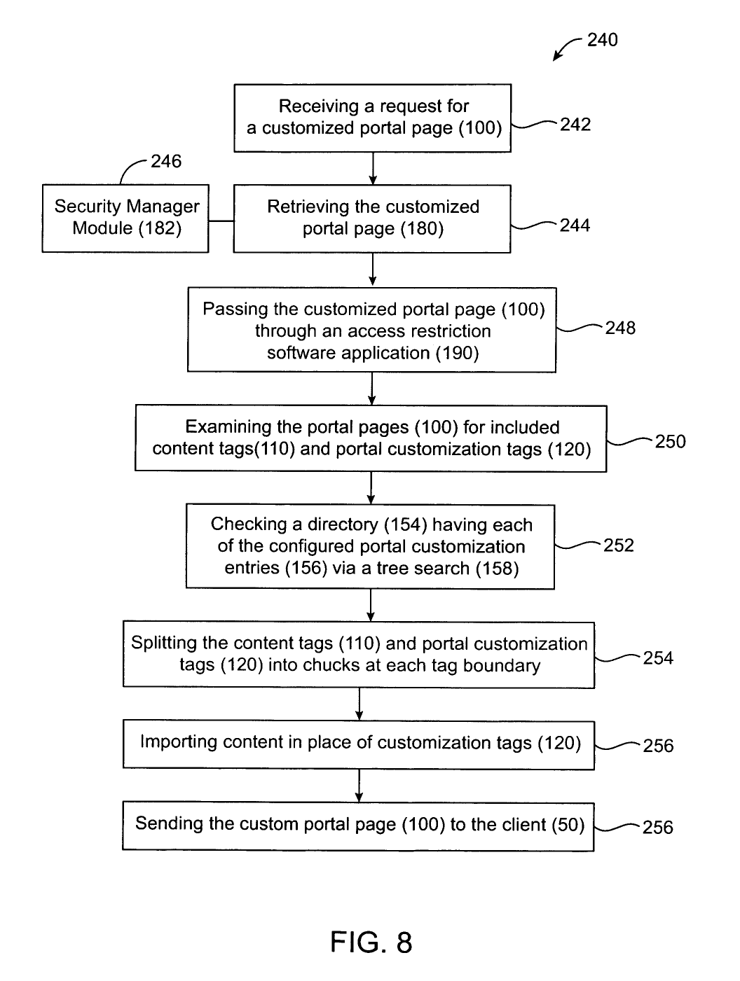

FIG. 8 shows a flow chart for retrieval and delivery 240 of the customized portal page 100 to the client 50. As shown in FIG. 8, it can be appreciated that when a request is received 242 for a customized portal page 100, a kernel 180 (or software application or module responsible for the communication between hardware and software components) will be used to retrieve 244 the pages 100 from the host 150. For example, in an Array Network SSL VPN device 10, the kernel 180 will preferably be a Security Manager module 182, which uses the local URL 164 to retrieve 246 the customized portal tags 120 from the host 150. However, it can be appreciated that any suitable kernel 180 or software application can be used.

Upon retrieval of the content or document from the host 150, the content 102 will be preferably passed 248 through a content mapping application 190, such as a Web Resource Mapping (WRM) feature or other suitable content mapping application, so that non-resource related content can be rewritten. The content mapping application 190 will then examine 250 the portal pages 100 for included portal customization tags 120. The pages 100 are preferably split into chucks at each tag boundary. The appropriate content 102 will then be inserted based on the portal customization tag 120 information, and the final portal page 100 sent to the client 50.

It can be appreciated that in accordance with one embodiment, the kernel portion 180 in addition to storing the configuration, the kernel portion 180 will also perform the tag parsing and content insertion. When a request is received by the VPN device 10 for content (i.e., portal page 100), a check 252 will be made against a database 154 having each of the configured portal customization entries 156. For efficiency the check can be made using a radix tree, a Patricia trie/tree, or a crit bit tree search 158. Preferably the check will be a Patricia tree; however any suitable search structure can be used. If there is a match, a portal customization resource 182 will be used. The request will be serviced by the host 150 on the VPN device 10. It can be appreciated that in the userland section, the mismatch between the URL format and the actual path that files are stored, is configured to remove the need for the developer to know the specific directory information on the VPN device 10. However, in order to allow the host 150, to find the file, the Security Manager 182 will modify the URL 164 just before it services the request.

When the Security Manager 182 receives the response, it will check if the response was for portal customization content. If so, and if the content-type of the response is one that allows portal customization tags 120 (for example, images would not contain any tags), it will pass the content to the portal customization module. The portal customization module will then parse the content for portal customization tags 120, and when found, replace 256 the tags 120 with actual content. It can be appreciated that in a preferred embodiment, no portal customization tags 120 will be left in the final response data. In order to support the new portal customization tags 120, two additional state tables 132 can be added to the kernel 180 parsers, one for tags (pc_tag) 134 and one for attributes (pc_attr) 136.

The tag replacement will preferably be done in a memory optimal way. However, it can be appreciated that any suitable replacement method can be used. In use, when a portal customization tag 120 is found, the content will be split 254 at the start of the tag 120. The tag 120 will then be parsed, and the content split again at the end of the tag. The appropriate function will be called to generate the tag content 122. At this point there will be four content pieces: pre-tag, tag, post tag, and tag content 122. The tag piece will be freed. The pre-tag, tag content 122, and post-tag pieces will be joined together, and parsing will continue with the first byte of the post-tag piece. Several functions can be added to support the generation of each specific tag. In addition, it can be appreciated that where possible these functions will mirror or reuse existing function. The custom portal page 100 is then send 258 to the client 50, wherein the content tags 110 and the customization tags 120 generate a portal theme when served to the client 50.

### IMPLEMENTATION EXAMPLE

It can be appreciated that in accordance with one embodiment, the following commands can be added to a shell site:

[no] portal theme create<theme name>

Create a new portal theme or delete an existing theme and all imported content.

show portal theme create

Display a list of configured portal themes.

portal theme object<keyword><theme name><object name><URL><filetype>

### Imports an external resource of type <filetype> into theme <theme name> from <URL> and associates it with the identifier <object name>. This resource replaces the default portal page <keyword> specified, or is an unattached custom resource.

The list of valid page identifiers for <keyword> is:
autolaunch—The page for autolaunching the Application Manager and L3VPN.
choose_site—The root page for shared virtual sites.
clientapp—The Application Manager template page.
fileshare—The template page for fileshare operation pages.
fshare_auth—The user credential page for authenticating to fileservers.
info—The template page for information and error pages.
login—The login page.
logout—The logout page.
new_pin—The page for SecurID new pin selection.
next_token—The page for SecurID next token mode.
passchange—The page for changing a user's LocalDB password.
tcs_page—The Thin Client template page.
welcome—The welcome portal page.
custom—An arbitrary resource not associated with any default portal page.

The list of valid filetypes for <filetype> is: html, css, js, htc, xml, text, and binary.

It should be appreciated that in accordance with one embodiment, <theme name> and <object name> should be at most 20 characters long, and should only contain ASCII characters a-z, A-Z, 0-9, ., -, and _. All other characters are preferably restricted.

Any portal page not assigned a custom object will remain the default page.

show portal theme object <theme name>[object name]

Display a list of resources imported for theme <theme name>. If the [object name] is given, resource embedded within that object will be displayed along with their file sizes.

portal theme assign <keyword><theme name><object name>

Reassign object <object name> from its current portal page to the new page <keyword>.

[no|show] portal theme active

Display or remove the currently active theme from the virtual site.

portal theme import <url> [theme name]

Import a prepackaged theme from <url>. If no [theme name] is given, the filename of the package file minus the file extension (if any) will be used as the theme name. The package file must be a ZIP format archive. It must have at its base level a file named “index.txt” which must list all theme object resources included in the theme. The format for this listing will be multiple lines consisting of:
<keyword><object name>/<filename><filetype>
   These fields correspond to the fields in the portal theme object command. The directly layout of the files must correspond to this listing, i.e., there must be a subdirectory named <object name> containing <filename> and all associated resources.

### Supported Tags

For example, the following HTML tags are supported:

<_AN_web_links>

Purpose: The ACL filtered list of configured portal link entries.

Attributes: All options are optional and may be omitted.

rows=“#” or cols=“#”: How many rows or columns to organize the links into. Only one

can be specified. The default portal page is equivalent to cols=“2”.

class=“class”: Specify a style sheet class for the links.

bullet=“url”: Specify an image to use as a bullet icon.

denied=“text”: Specify text to be used if no links are configured or permitted.

<_AN_fileshare_links>

Purpose: The list of configured fileshare entries.

Attributes: All options are optional and may be omitted.

rows=“#” or cols=“#”: How many rows or columns to organize the links into. Only one can be specified. The default portal page is equivalent to cols=“2”.

class =“class”: Specify a style sheet class for the links.

bullet=“url”: Specify an image to use as a bullet icon.

denied=“text”: Specify test to be used if no links are configured or permitted.

<_AN_tes_links>

Purpose: The ACL filtered list of configured tcs module entries.

Attributes: All options are optional and may be omitted.

rows=“#” or cols=“#”: How many rows or columns to organize the links into. Only one can be specified. The default portal page is equivalent to cols=“2”.

class=“class”: Specify a style sheet class for the links.

bullet=“url”: Specify an image to use as a bullet icon.

denied=“text”: Specify test to be used if no links are configured or permitted.

<_AN_clientapp_list>

Purpose: The ACL filtered list of configured clientapp service entries.

Attributes: All options are optional and may be omitted.
rows=“#” or cols=“#”: How many rows or columns to organize the links into.

Only one can be specified. The default portal page is equivalent to cols=“2”.
class=“class”: Specify a style sheet class for the links.
bullet=“url”: Specify an image to use as a bullet icon.

denied=“text”: Specify test to be used if no links are configured or permitted.

<_AN_winredir_list>

Purpose: The ACL filtered list of configured clientapp winredir ip/exe entries.

Attributes: All options are optional and may be omitted.
rows=“#” or cols=“#”: How many rows or columns to organize the links into.

Only one can be specified. The default portal page is equivalent to cols=“2”.
class=“class”: Specify a style sheet class for the links.
bullet=“url”: Specify an image to use as a bullet icon.

denied=“text”: Specify test to be used if no links are configured or permitted.

<_AN_fileshare_content>

Purpose: The relevant fileshare content will be inserted. This tag is only valid for the page configured using the keyword “fileshare”.

Attributes: There are no options for this tag.

class=“class”: Specify a style sheet class for the button/input text.

<_AN_browse>

Purpose: The browse input/button from the default portal page, used for browsing to an arbitrary URL through the SP.

Attributes: All options are optional and may be omitted.

<_AN_clientapp_applet>

Purpose: The clientapp applet object.

Attributes: There are no options for this tag.

<_AN_{—}13vpn_activex>

Purpose: The L3VPN activex object.

Attributes: There are no options for this tag.

In addition, the following JavaScript tags are supported:

<_AN_web_links_var>

Purpose: An array of ACL filtered web link objects containing the text and url for each link.

<_AN fileshare_links_var>

Purpose: An array of ACL filtered fileshare link objects containing the text and url for each link.

<_AN_tcs_links_var>

Purpose: An array of ACL filtered tcs link objects containing the text and url for each link.

<_AN_clientapp_list_var>

Purpose: An array of ACL filtered clientapp service entries.

<_AN_winredir_list_var>

Purpose: An array of ACL filtered clientapp winredir ip/exe entries.

<_AN_clientapp_launch_script>

Purpose: The required JavaScript functions for clientapp operations.

The above are exemplary modes of carrying out the invention and are not intended to be limiting. It will be apparent to those of ordinary skill in the art that modifications thereto can be made without departure from the spirit and scope of the invention as set forth in the following claims.

What is claimed is:

1. A method of generating a customized portal page for a virtual private network (VPN) device comprising:
configuring at least one custom portal page for a virtual private network (VPN) device, the at least one custom portal page having content tags and portal customization tags adapted to produce a portal theme;
importing the content tags and the portal customization tags into the VPN device for hosting; and
replacing the content tags and the portal customization tags with content when served to a client, wherein the content tags and the portal customization tags generate a portal theme when served to the client.

2. The method of claim 1, wherein the step of importing the content tags and the portal customization tags is performed using a userland agent.

3. The method of claim 1, wherein the content tags and the portal customization tags are hosted within a directory within the VPN device.

4. The method of claim 1, wherein the hosting of the content and portal customization tags is outside of a kernel.

5. The method of claim 1, further comprising performing a resource separation validation of an original URL for any customized portal content.

6. The method of claim 1, further comprising passing the content through a content mapping feature so that non-resource related content can be rewritten.

7. The method of claim 1, further comprising parsing each of the portal customization tags for embedded content links, importing any content found including style sheets, images, JavaScript, and rewriting the links thereto.

8. The method of claim 1, further comprising checking a directory having each of the at least one customized portal pages via a tree search.

9. The method of claim 1, further comprising examining the pages for the content tags and the portal customization tags and splitting the pages into chunks at each tag boundary.

10. A method of generating a customized portal page for a virtual private network (VPN) device comprising:
configuring at least one custom portal page for a virtual private network (VPN) device having static content tags and dynamic content tags, wherein the static and dynamic tags describe how the text should be formatted when a browser displays the content tags;
importing the static and dynamic content tags into the VPN device;
hosting the static and dynamic content tags on the VPN device; and
replacing the static and dynamic content tags with content when served to a client.

11. The method of claim 10, wherein the static and dynamic content tags provide a plurality of portal themes to the at least one custom portal page.

12. The method of claim 10, further comprising parsing each of the portal customization tags for embedded content links, importing any content found including style sheets, images, JavaScript, and rewriting the links thereto.

13. The method of claim 10, further comprising passing the content through a content mapping feature so that non-resource related content can be rewritten.

14. The method of claim 10, further comprising examining the pages for the static and dynamic content tags and splitting the pages into chunks at each tag boundary.

15. A system for customizing a portal page comprising:
a virtual private network (VPN) device, the VPN device comprising:
at least one application server configured to host the customized portal page, the customized portal page having static content tags and customized portal tags;
a web server for serving the portal page associated therewith;
a network access server used by the Internet service provider (ISP) for the client to access the VPN device; and
a VPN network and policy management device.

16. The system of claim 15, further comprising:
a client having a browser, wherein the browser is configured to open a connection to a VPN device and initiates a request to the VPN device for a customized portal page; and
a public network.

17. The system of claim 15, wherein the VPN device further includes a web accelerator that reduces web site access times, and at least one proxy server.
